(19) United States
(12) Patent Application Publication
(10) Pub. No.: US 2009/0048695 A1
(43) Pub. Date: Feb. 19, 2009

(54) SOUND-QUALITY IMPROVING APPARATUS AND METHOD, AND COMPUTER PROGRAM

(75) Inventor: Makoto Shirahama, Saitama (JP)

Correspondence Address: YOUNG & THOMPSON, 209 Madison Street, Suite 500, ALEXANDRIA, VA, 22314, US

(73) Assignee: PIONEER CORPORATION

(21) Appl. No.: 12/162,229

(22) PCT Filed: Jan. 23, 2007
(86) PCT No.: PCT/JP2007/051001

§ 371 Date: Jul. 25, 2008

(30) Foreign Application Priority Data
Jan. 26, 2006 (JP) 2006-017631

(51) Int. Cl. G06F 17/00

(52) U.S. Cl. 700/94

(57) ABSTRACT

A sound-quality enhancing device has delay elements for delaying a processed sound signal generated by subjecting an original sound signal to a predetermined type of processing by a predetermined time thereby to generate a basic sound signal, delaying the processed sound signal by a time shorter than the predetermined time thereby to generate a backward sound signal, and delaying the processed sound signal by a time longer than the predetermined time thereby to generate a forward sound signal. The sound-quality enhancing device further has effect sound generating elements for generating an effect sound signal producing an effect sound added to the basic sound generated by a basic sound signal from at least the generated backward and forward sound signals and combining elements for adding the generated effect sound signal to the basic sound signal.

### TECHNICAL FIELD

The present invention relates to a sound-quality improving apparatus for and method of increasing a sound quality related to an audio signal, such as a sound improving apparatus for improving a sound quality that has deteriorated with compression coding in an audio signal inputted in a decoded status after the compression coding, and a computer program which makes a computer function as the sound-quality improving apparatus.

### BACKGROUND ART

There have been rapidly increased opportunities to listen to an audio signal with a relatively high compressibility, such as MP3 (MPEG Audio Layer-3) and WMA (Windows Media Audio), as this type of compressing-coded audio signal. As this background, it is pointed out that MP3 and WMA or the like are suitable for the communication on the Internet and a portable audio with a strict capacity limit; however, there is also pointed out such a disadvantage that a sound quality in the reproduction deteriorates compared to the original audio signal because of the high compression.

In order to address the aforementioned disadvantage, for example, there has been suggested a frequency interpolating apparatus (patent document 1) for restoring a signal that is close to an original signal, by approximately generating a suppressed frequency component from an input signal with the frequency component suppressed, in a particular frequency band of the original signal, and by adding the generated component to the input signal.

Patent document 1: Japanese Patent Application NO. 2003-522910

### DISCLOSURE OF INVENTION

### Subject to be Solved by the Invention

However, the frequency interpolating apparatus disclosed in the aforementioned patent document 1 possibly has the following technical problem.

That is, the aforementioned frequency interpolating apparatus improves the sound quality merely by interpolating a lost frequency component, and there is a possibility that it cannot achieve the improvement of a feeling of rising and inflection. In addition, an addition level when the generated frequency component is added to the input signal is obtained by analyzing a huge physical quantity related to a signal spectrum, for example, so that the scale of the analysis or the scale of the apparatus itself possibly increases, and it is possibly hard to mount the apparatus at low cost.

It is therefore an object of the present invention to provide a relatively small-sized sound-quality improving apparatus and method, which can improve a sound quality that has deteriorated with some process in a processed audio signal obtained by performing the process, and a computer program which makes a computer function as the sound-quality improving apparatus.

### Means for Solving the Subject

(Sound-Quality Improving Apparatus)

The above object of the present invention can be achieved by a sound-quality improving apparatus provided with: a delaying device for generating a basic sound signal by delaying a processed audio signal obtained by performing a predetermined type of process on an original audio signal, for a predetermined time, for generating a behind sound signal by delaying the processed audio signal for a shorter time than the predetermined time, and for generating an advance sound signal by delaying the processed audio signal for a longer time than the predetermined time; an effect-sound generating device for generating an effect sound signal, which indicates an effect sound for a basic sound indicated by the basic sound signal, at least on the basis of the generated behind sound signal and the generated advance sound signal; and a synthesizing device for synthesizing the generated effect sound signal with the basic sound signal.

According to the present invention, in its operation, the delaying device, which is formed of e.g. a delay circuit, delays the processed audio signal, which is inputted from a decoder or the like, for a predetermined time, to thereby generate the basic sound signal. Here, the “processed audio signal” is a signal obtained by performing some process on the original audio signal, and is typically a signal on which at least one portion of a decoding process is performed after the compression coding. For example, it is a PCM (Pulse Code Modulation) signal obtained by decoding (in other words, decompressing) highly compressed audio data, such as MP3 or WMA; however, it may be a PCM signal obtained by A/D converting a normal CD (Compact Disc) or analog input signal. In the original audio signal, such as compression-coded data, which is an origin of the processed audio signal, signal deterioration occurs upon the processing, to a greater or lesser extent. Typically, in the compression coding, the original component is eliminated on the basis of a time masking curve and a signal that is eliminated because it is equal to or less than the smallest audible limit curve, and the sound quality deteriorates compared to the original sound source. That is why some sound-quality improving action is required.

In parallel with or in tandem with the generation of the basic sound signal described above, the delaying device delays the processed audio signal for the shorter time than the predetermined time, to thereby generate the behind sound signal. Here, the “shorter time” may be equal to or greater than “0” as long as it is shorter than the predetermined time; namely, it may include the case that it is not delayed at all. Moreover, it may include the case that it is advanced relatively to the basic sound signal or that it is advanced on a time axis. On the other hand, the delaying device delays the processed audio signal for the longer time than the predetermined time, to thereby generate the advance sound signal.

Each of the behind sound signal and the advance sound signal is generated as at least one signal, and if a plurality of behind sound signals are generated, their delay times are different from each other. In the same manner, if a plurality of advance sound signals are generated, their delay times are different from each other. For example, the behind sound signals may be a signal which is 0.6 ms delayed and a signal which is 1.1 ms delayed with respect to the basic sound signal. On the other hand, the advance sound signals may be a signal that is 0.15 ms ahead and a signal that is 0.8 ms ahead with respect to the basic sound signal.

Then, at least on the basis of the behind sound signal and the advance sound signal generated as described above, the effect sound signal, which indicates the effect sound for the basic sound indicated by the basic sound signal, is generated by the effect-sound generating device. The “at least on the basis of the behind sound signal and the advance sound signal generated” herein indicates, in effect, that it may be based on only the two types of signals, or that it may be “based on “the basic sound signal” in addition to those signals.

Moreover, the effect sound signal generated in this manner is synthesized with the basic sound signal by the synthesizing device, which is formed of e.g. a synthesis circuit, to thereby add the effect sound to the basic sound. By synthesizing not only the advance behind sound signal but also the behind advance sound signal with the basic sound signal as the effect sound in this manner, the feeling of rising and inflection is improved, which is assumed by a sound eliminated in the compression based on a time masking effect curve. At this time, for example, a delay circuit and a synthesis circuit can be used as the delaying device and the synthesizing device. Thus it is possible to reduce the scale of the apparatus itself, as much as possible.

Incidentally, the aforementioned predetermined time may be determined in advance for each type or each individual so as to satisfy the performance and the specification required for the actual sound-quality improving apparatus, by obtaining the relationship between the time shift from the basic sound signal and its effect, on an experimental, experiential, or simulation basis in advance. Moreover, such a predetermined time may be changed during the use or checking of the apparatus. In addition, with regard to the difference between the predetermined time and the delay time of the behind sound signal and the difference between the predetermined time and the delay time of the advance sound signal, they are preferably small; however, a specific difference value is individually and specifically set, depending on what type of effect sound is to be generated, and a reasonable effect can be achieved, regardless of whether the difference value is large or small. That is, “behind” or “advance” in the “behind sound signal” and the “advance sound signal” of the present invention does not have a quantitative meaning in time.

In addition, in generating various signals delayed in such a delayed form in time, it is also possible to perform a FFT (Fast Fourier Transform) analysis to generate a near-by frequency; however, preferably the delaying device, which is formed of e.g. a delay circuit, is used to thereby significantly reduce a required DSP (Digital Signal Processor) resource.

As a result, it is possible to preferably improve and output the sound quality that has deteriorated in the processed audio signal, using the relatively small-sized apparatus. For example, not only the advance behind sound signal but also the behind advance sound signal are used as the effect sound, which allows a signal lost on a time axis to be restored. Thus, the feeling of rising and inflection is improved, which is assumed by a sound eliminated on the basis of the time masking effect curve in the compression.

In one aspect of the sound-quality improving apparatus of the present invention, the effect-sound generating device generates a medium to low-frequency effect sound signal, which indicates a medium to low-frequency effect sound for the basic sound, as one portion of the effect sound signal, on the basis of the generated behind sound signal and the generated advance sound signal, and generates a medium to high-frequency effect sound signal, which indicates a medium to high-frequency effect sound for the basic sound, as another portion of the effect sound signal, on the basis of the generated behind sound signal and the generated advance sound signal.

According to this aspect, the medium to low-frequency effect sound signal, which indicates the medium to low-frequency (for example, but not limited to, a frequency range of 300 Hz or less) for the basic sound, is generated as one portion of the effect sound signal, on the basis of the generated behind sound signal and the generated advance sound signal. In parallel with or in tandem with this, the medium to high-frequency effect sound signal, which indicates the medium to high-frequency (for example, but not limited to, a frequency range of 4 kHz or more) for the basic sound, is generated as another portion of the effect sound signal, on the basis of the generated behind sound signal and the generated advance sound signal. Therefore, it is possible to preferably improve and output the sound quality that has deteriorated in the processed audio signal inputted. For example, a sound fluctuation in the medium to high-frequency allows a natural effect to be added in some characteristic of a music signal to be inputted, so that it is expected to improve the sound quality of vocal music.

In another aspect of the sound-quality improving apparatus of the present invention, the effect-sound generating device generates the effect sound signal on the basis of the generated basic sound signal, in addition to the generated behind sound signal and the generated advance sound signal.

According to this aspect, the effect sound signal is generated on the basis of the generated basic sound signal, in addition to the generated behind sound signal and the generated advance sound signal. Therefore, the balance in the entire frequency range of the effect sound signal is relatively improved.

In an aspect related to the effect-sound generating device, the effect-sound generating device may generate a medium to low-frequency effect sound signal, which indicates a medium to low-frequency effect sound for the basic sound, as one portion of the effect sound signal, on the basis of the generated behind sound signal and the generated advance sound signal, and generates a medium to high-frequency effect sound signal, which indicates a medium to high-frequency effect sound for the basic sound, as another portion of the effect sound signal, on the basis of the generated basic sound signal.

According to this aspect, the medium to low-frequency effect sound signal is generated as one portion of the effect sound signal, on the basis of the generated behind sound signal and the generated advance sound signal. In parallel with or in tandem with this, the medium to high-frequency effect sound signal is generated as another portion of the effect sound signal, on the basis of the generated basic sound signal. Therefore, the balance in the medium to high-frequency is relatively improved, and it is possible to preferably improve and output the sound quality that has deteriorated in the processed audio signal inputted overall.

In each aspect related to the medium to low-frequency effect sound signal described above, it may be further provided with: an amplifying device for amplifying a signal level of the generated medium to low-frequency effect sound signal at a variable amplification factor and for amplifying a signal level of the generated medium to high-frequency effect sound signal at a variable amplification factor; and an amplification-factor controlling device for changing the variable amplification factor.

According to this aspect, each of the signal level of the generated medium to low-frequency effect sound signal and the signal level of the generated medium to high-frequency effect sound signal is amplified at the variable amplification ratio by the amplification-factor controlling device. Therefore, it is possible to recover the quality of the original audio signal, which is lost because of the predetermined type of process, to a greater or lesser extent. Specifically, a sound volume and density are supplemented in the medium to low-frequency and the medium to high-frequency.

In an aspect related to the medium to low-frequency effect sound signal described above, the amplification-factor controlling device may have a microcomputer for controlling the amplifying device to change the variable amplification factor.

According to this aspect, the amplifying device is controlled by the microcomputer to change the variable amplification factor. For example, if the processed audio signal is WMA or MP3, the bit rate of the signal is recognized by the microcomputer, and the variable amplification factor is changed in accordance with the bit rate. Alternatively, the input function of a product equipped with the sound-quality improving apparatus is recognized by the microcomputer, and the variable amplification factor is changed in accordance with the input function. Therefore, it is possible to generate the more proper effect sound signal, in restoring the original audio signal.

Alternatively, in an aspect related to the medium to low-frequency effect sound signal described above, the amplification-factor controlling device has a sound-pressure detection circuit for detecting a sound pressure of the effect sound and for controlling the amplifying device to change the variable amplification factor in accordance with the detected sound pressure.

According to this aspect, for example, the sound pressure of the effect sound is detected by the sound-pressure detection circuit, which is formed of e.g. an integration circuit, and the variable amplification factor is changed in accordance with the detected sound pressure. At this time, the sound pressure of the effect sound may be detected not only directly but also indirectly form another physical quantity. If the sound pressure of the effect sound detected is too much bigger than that of the basic sound, the variable amplification factor is relatively reduced. In this manner, the effect sound preferably corrected in accordance with the sound pressure of the effect sound is synthesized with the basic sound.

Alternatively, in an aspect related to the medium to low-frequency effect sound signal described above, the amplification-factor controlling device may have a sound-pressure detection circuit for detecting a sound pressure of the basic sound and for controlling the amplifying device to change the variable amplification factor in accordance with the detected sound pressure.

According to this aspect, firstly, the sound pressure of the basic sound signal is detected by the sound-pressure detection circuit, instead of that of the effect sound. At this time, the sound pressure of the basic sound may be detected in a divided plurality of frequency bands, or may be detected as a synthesis sound pressure in the entire frequency band without the band divided. Then, the variable amplification factor is changed in accordance with the detected sound pressure. Therefore, the effect sound which is relatively well-balanced not only in the medium to low-frequency or the medium to high-frequency but in the entire frequency, is synthesized with the basic sound.

In another aspect of the sound-quality improving apparatus of the present invention, the effect-sound generating device generates a medium to low-frequency effect sound signal, which indicates a medium to low-frequency effect sound for the basic sound, as one portion of the effect sound signal, on the basis of the generated behind sound signal and the generated advance sound signal, and generates a high-frequency effect sound signal, which indicates a high-frequency effect sound for the basic sound, as another portion of the effect sound signal, on the basis of the generated basic sound signal.

According to this aspect, the medium to low-frequency effect sound signal, which indicates a medium to low-frequency effect sound for the basic sound, is generated as one portion of the effect sound signal, and the high-frequency effect sound signal, which indicates a high-frequency effect sound for the basic sound, is generated as another portion of the effect sound signal, on the basis of the generated basic sound signal. Therefore, it is possible to compensate the high-frequency component, which is lost from the original audio signal as a result of the predetermined type of process. For example, it is possible to compensate a high-frequency component of 16 kHz or more, which is lost in converting to 128 kbs MP3.

In this aspect, the effect-sound generating device may have a high-frequency generation circuit for generating an n-th harmonic sound (n is a natural number of 2 or more) of the basic sound signal, as a device for generating the high-frequency effect sound signal.

According to this aspect, the n-th harmonic sound of the basic sound signal is generated as the high-frequency effect sound signal. For example, the two-time sound (i.e. second harmonic) of the basic sound signal is generated. Therefore, it is possible to compensate the high-frequency component, which is lost from the original audio signal as a result of the predetermined type of process, more naturally.

In another aspect of the sound-quality improving apparatus of the present invention, it is further provided with: another delaying device for generating a delay sound signal by delaying the processed audio signal for a time different from the predetermined time; and another effect-sound generating device for generating a medium to high-frequency effect sound signal, which indicates a medium to high-frequency effect sound for the basic sound indicated by the basic sound signal, on the basis of the generated delay sound signal, the effect-sound generating device generating a medium to low-frequency effect sound signal, which indicates a medium to low-frequency effect sound for the basic sound, as the effect sound signal, on the basis of the generated behind sound signal and the generated advance sound signal, the synthesizing device synthesizing the generated medium to low-frequency effect sound signal and the generated medium to high-frequency effect sound signal, with the basic sound signal.

According to this aspect, another delaying device delays the processed audio signal for the time different from the predetermined time related to the medium to low-frequency effect sound signal (preferably, a shorter time than the predetermined time related to the medium to low-frequency effect sound signal, and near the basic sound signal), to generate the delay sound signal. On the basis of the delay sound signal generated in this manner, the medium to high-frequency effect sound signal is generated by another effect-sound generating device. Simultaneously with or in tandem with this, the medium to low-frequency effect sound signal is generated by the effect-sound generating device, on the basis of the generated behind sound signal and the generated advance sound signal. Then, the generated medium to low-frequency effect sound signal and the generated medium to high-frequency effect sound signal are synthesized with the basic sound signal by the synthesizing device. Therefore, it is possible to set the degree of the delay to be different, between the medium to high-frequency effect sound signal and the medium to low-frequency effect sound signal. For example, it is possible to reduce a peak and a dip which can occur in the frequency characteristic of the medium to high-frequency effect sound (in particular, high-frequency), as much as possible.

In each aspect related to the effect-sound generating device described above, the effect-sound generating device may perform a filtering process separately on the generated behind sound signal and the generated advance sound signal, as one portion of a process of generating the effect sound signal.

According to this aspect, the filtering process (the filtering process herein includes a low-pass process, a high-pass process, and a band-pass process) is performed separately, on the generated behind sound signal and the generated advance sound signal, as one portion of the process of generating the effect sound signal. That is, the frequency band to be cut varies depending on how much delayed each of the generated behind sound signal and the generated advance sound signal is from the basic signal. Thus, it is possible to set the sound quality of the effect sound, more finely.

Alternatively, in each aspect related to the effect-sound generating device described above, the delaying device may generate a plurality of the behind sound signals by delaying the processed audio signal for a plurality of times which are shorter than the predetermined time and which are different from each other, and generates a plurality of the advance sound signals by delaying the processed audio signal for a plurality of times which are longer than the predetermined time and which are different from each other, and the effect-sound generating device may perform a filtering process separately on the generated plurality of behind sound signals and the generated plurality of advance sound signals, as one portion of a process of generating the effect sound signal.

According to this aspect, the plurality of the behind sound signals are generated by delaying the processed audio signal for the plurality of times (e.g. 0.99 ms, 0.97 ms, and the like) which are shorter than the predetermined time (e.g. 1.00 ms) and which are different from each other. Simultaneously with or in tandem with this, the plurality of the advance sound signals are generated by delaying the processed audio signal for the plurality of times (e.g. 1.02 ms, 1.04 ms, and the like) which are longer than the predetermined time and which are different from each other. Incidentally, the plurality of behind sound signals and the plurality of advance sound signals are not necessary the same in number. The number of the behind sound signals and the advance sound signals is preferably larger in terms of sound-quality setting; however, for example, if there are two signals each, then it is sufficiently effective in practice. The effect-sound generating device performs the filtering process separately on the plurality of behind sound signals and the plurality of advance sound signals generated in this manner, to generate the effect sound signal, by which it is possible to set the sound quality of the effect sound, more finely.

Alternatively, in each aspect related to the effect-sound generating device described above, the effect-sound generating device may collectively perform a filtering process on the generated behind sound signal and the generated advance sound signal, as one portion of a process of generating the effect sound signal.

According to this aspect, the filtering process (the filtering process herein includes a low-pass process, a high-pass process, and a band-pass process) is collectively performed, on the generated behind sound signal and the generated advance sound signal, as one portion of the process of generating the effect sound signal. As a result, it is possible to avoid the complicated apparatus while improving the quality of the processed audio signal, to a greater or lesser extent.

Alternatively, in each aspect related to the effect-sound generating device described above, the delaying device may generate a plurality of the behind sound signals by delaying the processed audio signal for a plurality of times which are shorter than the predetermined time and which are different from each other, and generates a plurality of the advance sound signals by delaying the processed audio signal for a plurality of times which are longer than the predetermined time and which are different from each other, and the effect-sound generating device collectively may perform a filtering process on the generated plurality of behind sound signals and the generated plurality of advance sound signals, as one portion of a process of generating the effect sound signal.

According to this aspect, since the filtering process is collectively performed on the generated behind sound signal and the generated advance sound signal, it is possible to avoid the complicated apparatus while improving the quality of the processed audio signal, to a greater or lesser extent.

In each aspect related to the delaying device described above, it may be further provided with a preprocessing device for performing a process of reducing a signal level on the processed audio signal, at a pre-stage of the delaying device.

According to this aspect, the signal level is reduced to a greater or lesser extent, with respect to the processed audio signal, by the preprocessing device at the pre-stage of the delaying device. Thus, a head room is reserved for a DSP.

(Sound-Quality Improving Method)

The above object of the present invention can be achieved by a sound-quality improving method provided with: a delaying process of generating a basic sound signal by delaying a processed audio signal obtained by performing a predetermined type of process on an original audio signal, for a predetermined time, for generating a behind sound signal by delaying the processed audio signal for a shorter time than the predetermined time, and for generating an advance sound signal by delaying the processed audio signal for a longer time than the predetermined time; an effect-sound generating process of generating an effect sound signal, which indicates an effect sound for a basic sound indicated by the basic sound signal, at least on the basis of the generated behind sound signal and the generated advance sound signal; and a synthesizing process of synthesizing the generated effect sound signal with the basic sound signal.

According to the sound-quality improving method of the present invention, as in the case of the sound-quality improving apparatus of the present invention described above, it is possible to preferably improve and output the sound quality that has deteriorated in the processed audio signal.

Incidentally, the sound-quality improving method of the present invention can also employ the same various aspects as those of the aforementioned sound-quality improving apparatus of the present invention.

(Computer Program)

The above object of the present invention can be also achieved by a computer program making a computer function as: a delaying device for generating a basic sound signal by delaying a processed audio signal obtained by performing a predetermined type of process on an original audio signal, for a predetermined time, for generating a behind sound signal by delaying the processed audio signal for a shorter time than the predetermined time, and for generating an advance sound signal by delaying the processed audio signal for a longer time than the predetermined time; an effect-sound generating device for generating an effect sound signal, which indicates an effect sound for a basic sound indicated by the basic sound signal, at least on the basis of the generated behind sound signal and the generated advance sound signal; and a synthesizing device for synthesizing the generated effect sound signal with the basic sound signal.

According to the computer program of the present invention, the aforementioned sound-quality improving apparatus of the present invention can be relatively easily realized as a computer reads and executes the computer program from a program storage device, such as a ROM, a CD-ROM, a DVD-ROM, and a hard disk, or as it executes the computer program after downloading the program through a communication device. By this, as in the case of the sound-quality improving apparatus of the present invention described above, it is possible to preferably improve and output the sound quality that has deteriorated in the processed audio signal.

The above object of the present invention can be also achieved by a computer program product in a computer-readable medium for tangibly embodying a program of instructions executable by a computer provided in the sound-quality improving apparatus of the present invention described above (including its various aspects), the computer program product making the computer function as at least one portion of the delaying device, the effect-sound generating device, and the synthesizing device.

According to the computer program product of the present invention, the aforementioned sound-quality improving apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the sound-quality improving apparatus of the present invention.

As explained above, according to the sound-quality improving apparatus of the present invention, it is provided with the delaying device, the effect-sound generating device, and the synthesizing device. According to the sound-quality improving method of the present invention, it is provided with the delaying process, the effect-sound generating process, and the synthesizing process. Thus, it is possible to improve the sound quality that has deteriorated with some process in the processed audio signal obtained by performing the some process. Moreover, according to the computer program of the present invention, it makes a computer function as the delaying device, the effect-sound generating device, and the synthesizing device. Thus, it is possible to relatively easily construct the sound-quality improving apparatus of the present invention described above.

These effects and other advantages of the present invention will become more apparent from the embodiments explained below.

### BRIEF DESCRIPTION OF DRAWINGS

FIG. 1 is a block diagram conceptually showing the basic structure of a sound-quality improving apparatus in embodiments.

FIG. 2 is a block diagram conceptually showing the structure of a sound-quality improving apparatus in a first embodiment.

FIG. 3 is a block diagram conceptually showing the structure of a sound-quality improving apparatus in a comparison example.

FIG. 4 is a characteristic diagram showing a difference in a frequency characteristic between the sound-quality improving apparatus in the first embodiment and the sound-quality improving apparatus in the comparison example.

FIG. 5 is a block diagram conceptually showing the structure of a sound-quality improving apparatus in a second embodiment.

FIG. 6 is a block diagram conceptually showing the structure of a sound-quality improving apparatus in a third embodiment.

FIG. 7 is a block diagram conceptually showing the structure of a sound-quality improving apparatus in a fourth embodiment.

FIG. 8 is a block diagram conceptually showing the structure of a sound-quality improving apparatus in a fifth embodiment.

FIG. 9 is a block diagram conceptually showing the structure of a sound-quality improving apparatus in a sixth embodiment.

FIG. 10 is a block diagram conceptually showing the structure of a sound-quality improving apparatus in a seventh embodiment.

FIG. 11 is a block diagram conceptually showing the structure of a sound-quality improving apparatus in an eighth embodiment.

### DESCRIPTION OF REFERENCE CODES

1 amplifier circuit
2 delay circuit
3 amplifier circuit
4 synthetic circuit
7 synthetic circuit
51B medium to low-frequency BP filter
52B medium to high-frequency BP filter
61 amplifier circuit
62 amplifier circuit
51L LP filter
52H HP filter
61V variable amplifier circuit
62V variable amplifier circuit
6M microcomputer
61SP sound pressure detection circuit
62SP sound pressure detection circuit
6SP sound pressure detection circuit
52A harmonic generation circuit
2′ medium to high-frequency delay circuit
3′ medium to high-frequency amplifier circuit
4′ medium to high-frequency synthesis circuit
5L LP filter

### BEST MODE FOR CARRYING OUT THE INVENTION

Hereinafter, the best mode for carrying out the present invention will be explained in each embodiment in order with reference to the drawings.

(1) Basic Structure of Sound-Quality Improving Apparatus

Firstly, the basic structure of a sound-quality improving apparatus in embodiments will be explained with reference to FIG. 1. FIG. 1 is a block diagram conceptually showing the basic structure of the sound-quality improving apparatus in the embodiments.

In FIG. 1, the sound-quality improving apparatus in the embodiments is provided with: an amplifier circuit 1 as one example of the “preprocessing device” of the present invention; a delay circuit 2 as one example of the “delaying device” of the present invention; amplifier circuits 3 and a synthesis circuit 4 as one example of the “effect-sound generating device” of the present invention; and a synthesis circuit 7 as one example of the “synthesizing device” of the present invention. The sound-quality improving apparatus preferably improves and outputs a sound quality that has deteriorated in a compressed audio signal inputted.

The sound-quality improving apparatus in the embodiments is an apparatus for improving and then outputting the sound quality that has deteriorated with compression coding in a PCM signal, using the PCM signal as an input, wherein the PCM signal is one example of the “processed audio signal” of the present invention, obtained by decoding (in other words, decompressing) highly compressed audio data, such as MP3 and WMA.

The amplifier circuit 1 includes an amplifying element, such as a transistor, and is adapted to relatively reduce the signal level of the PCM signal obtained by decoding the highly compressed audio data, such as MP3 and WMA. By this, a head room is reserved for the process (specifically, DSP process) of the sound-quality improving apparatus in the embodiments, to thereby avoid clip.

The delay circuit 2 includes, for example, a delaying circuit, and is adapted to generate a plurality of delay signals which are delayed in time from the compressed audio signal transmitted by the amplifier circuit 1 electrically connected thereto, and which are one example of the “delay sound signal” of the present invention. Specifically, it is adapted to generate a plurality of delay signals which are delayed for n(0) [ms] to n(k) [ms] (wherein, n(0) to n(k) are predetermined real values) from the compressed audio signal. Then, for example, if n(m) [ms] of them is specified as a basic sound signal, it is possible to consider a signal that is ahead for a predetermined advance time (e.g. n(k)-n(m) [ms]) as an advance sound signal, and a signal that is delayed for a predetermined behind time (e.g. n(m)-n(0) [ms]) as a behind sound signal. Incidentally, preferably, if the predetermined advance time and the predetermined behind time are set to be different, it is possible to reduce a dip which occurs when the synthesis circuit 4 synthesizes the plurality of delay signals, as much as possible.

The amplifier circuits 3 are electrically connected to the delay circuit 2, and are adapted to adjust the level of each of the plurality of delay signals (e.g. the behind sound signal and the advance sound signal) generated as described above, as occasion demands.

The synthesis circuit 4 is electrically connected to each of the amplifier circuits 3, and is adapted to synthesize the behind sound signal and the advance sound signal in which the level is adjusted.

The synthesis circuit 7 is electrically connected to the synthesis circuit 4 and the delay circuit 2, and is adapted to generate an output signal by synthesizing the behind sound signal and the advance sound signal that are synthesized as described above, with the basic sound signal.

As described above, according to the basic structure of the sound-quality improving apparatus in the embodiments shown in FIG. 1, it is possible to preferably improve and output the sound quality that has deteriorated in the compressed audio signal inputted. For example, not only the advance sound signal but also the behind sound signal are used as the effect sound, which improves the feeling of rising and inflection, which are assumed by a sound eliminated in the compression based on a time masking effect curve.

### (1) FIRST EMBODIMENT

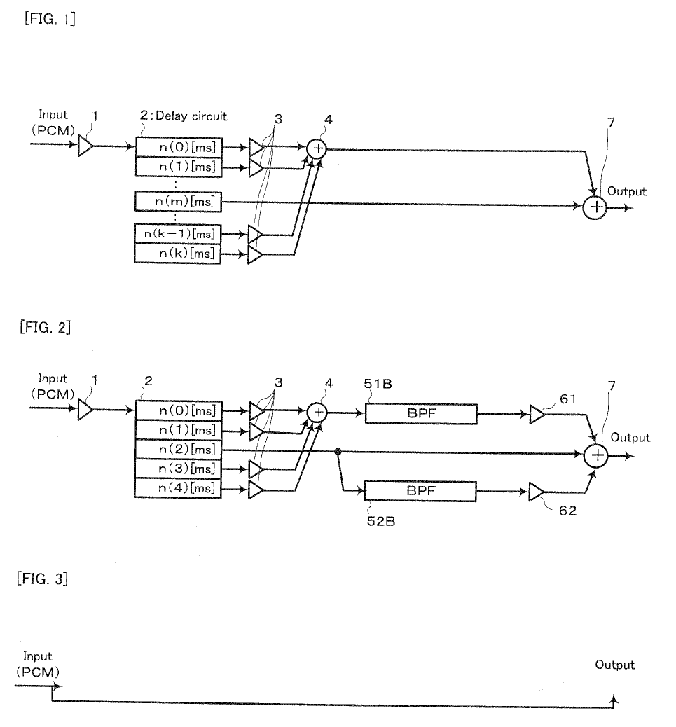

The structure of a sound-quality improving apparatus in a first embodiment will be explained with reference to FIG. 2 in addition to FIG. 1. FIG. 2 is a block diagram conceptually showing the structure of the sound-quality improving apparatus in the first embodiment. Incidentally, in FIG. 2, the same structure as that of FIG. 1 carries the same numerical reference, and the detailed explanation thereof will be omitted as occasion demands.

In FIG. 2, the sound-quality improving apparatus in the first embodiment is provided particularly with: a medium to low-frequency BP filter 51B and a medium to high-frequency BP filter 52B, as one example of the “effect-sound generating device” of the present invention; an amplifier circuit 61; and an amplifier circuit 62. The sound-quality improving apparatus in the first embodiment preferably improves and outputs the sound quality that has deteriorated in the compressed audio signal inputted, as follows.

The medium to low-frequency BP filter 51B includes, for example, a band-pass filter, is electrically connected to the synthesis circuit 4, and is adapted to generate a medium to low-frequency effect sound signal by passing 10 Hz to 300 Hz signals of the synthesized signal obtained by synthesizing the behind sound signal and the advance sound signal.

The medium to high-frequency BP filter 52B includes, for example, a IIR-type band-pass filter, is electrically connected to the delay circuit 2, and is adapted to generate a medium to high-frequency effect sound signal by passing 4 Hz to 12 Hz signals of the basic sound signal.

The amplifier circuit 61 is electrically connected to the medium to low-frequency BP filter 51B, and is adapted to adjust the signal level of the medium to low-frequency effect sound signal, as occasion demands.

The amplifier circuit 62 is electrically connected to the medium to high-frequency BP filter 52B, and is adapted to adjust the signal level of the medium to high-frequency effect sound signal, as occasion demands.

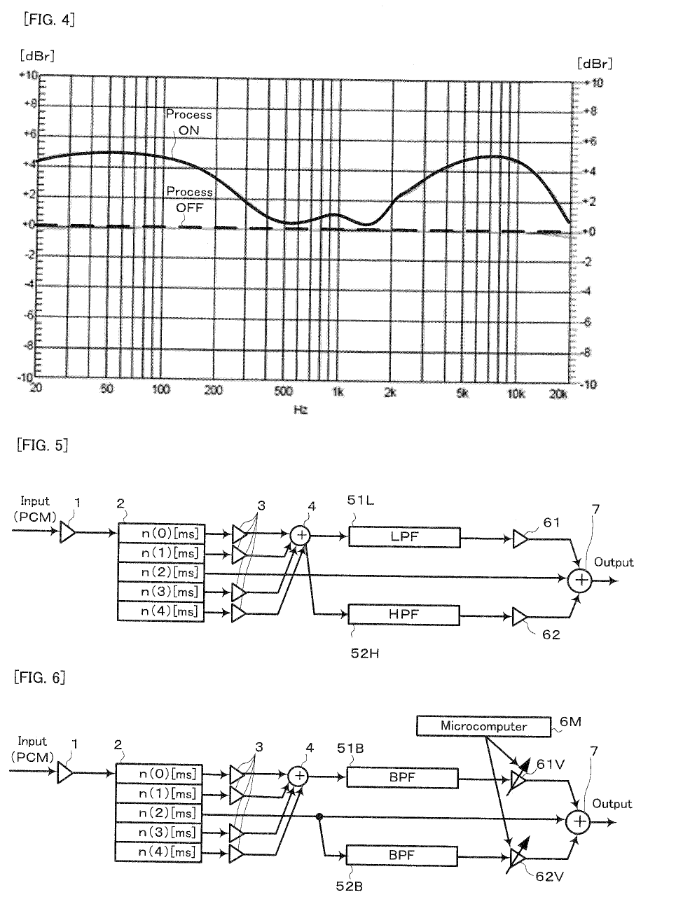

As described above, according to the sound-quality improving apparatus in the first embodiment shown in FIG. 2, it is possible to preferably improve and output the sound quality that has deteriorated in the compressed audio signal inputted. Specifically, as shown in FIG. 3 and FIG. 4 in addition to FIG. 2, the medium to low-frequency effect sound signal and the medium to high-frequency effect sound signal are synthesized with the basic sound signal, so that a sound volume relatively increases in the medium to low-frequency and the medium to high-frequency. FIG. 3 is a block diagram conceptually showing the structure of a sound-quality improving apparatus in a comparison example. FIG. 4 is a characteristic diagram showing a difference in a frequency characteristic between the sound-quality improving apparatus in the first embodiment and the sound-quality improving apparatus in the comparison example. That is, the frequency characteristic of the output signal, obtained by the sound-quality improving apparatus in the comparison example shown in FIG. 3, is flat in an entire frequency domain as in a dashed line (process OFF) in FIG. 4. On the other hand, the frequency characteristic of the output signal, obtained by the sound-quality improving apparatus in the first embodiment shown in FIG. 2, relatively rises in the medium to low-frequency and the medium to high-frequency as in a solid line (process ON) in FIG. 4, and the sound volume relatively increases. Here, the effect sound to be added to the basic sound signal is a sound signal generated by adding not only the advance sound signal but also the behind sound signal. Thus, it is possible to improve the feeling of rising and inflection of a music sound in the synthesized signal, and thus it is possible to preferably improve and output the sound quality that has deteriorated in the compressed audio signal inputted.

### (2) SECOND EMBODIMENT

The structure of a sound-quality improving apparatus in a second embodiment will be explained with reference to FIG. 5 in addition to FIG. 1 and FIG. 2. FIG. 5 is a block diagram conceptually showing the structure of the sound-quality improving apparatus in the second embodiment. Incidentally, in FIG. 5, the same structure as that of FIG. 1 and FIG. 2 carries the same numerical reference, and the detailed explanation thereof will be omitted as occasion demands.

In FIG. 5, the sound-quality improving apparatus in the second embodiment is provided particularly with: a LP filter 51L and a HP filter 52H, as one example of the “effect-sound generating device” of the present invention. The sound-quality improving apparatus in the second embodiment preferably improves and outputs the sound quality that has deteriorated in the compressed audio signal inputted, as follows.

The LP filter 51L includes, for example, a low-pass filter, is electrically connected to the synthesis circuit 4, and is adapted to generate the medium to low-frequency effect sound signal by passing 0 Hz to 300 Hz signals of the synthesized signal obtained by synthesizing the behind sound signal and the advance sound signal.

The HP filter 52H includes, for example, a high-pass filter, is electrically connected to the synthesis circuit 4, and is adapted to generate the medium to high-frequency effect sound signal by passing more than 4 Hz signals of the synthesized signal obtained by synthesizing the behind sound signal and the advance sound signal.

As described above, according to the sound-quality improving apparatus in the second embodiment shown in FIG. 5, it is possible to preferably improve and output the sound quality that has deteriorated in the compressed audio signal inputted. In particular, due to the frequency characteristic, a peak and a dip occur in the high-frequency signal; however, a sound fluctuation related to the medium to high-frequency effect sound signal allows a natural effect to be added in some characteristic of the compressed audio signal to be inputted, so that it is expected to improve the sound quality.

### (4) THIRD EMBODIMENT

The structure of a sound-quality improving apparatus in a third embodiment will be explained with reference to FIG. 6 in addition to FIG. 2. FIG. 6 is a block diagram conceptually showing the structure of the sound-quality improving apparatus in the third embodiment. Incidentally, in FIG. 6, the same structure as that of FIG. 2 carries the same numerical reference, and the detailed explanation thereof will be omitted as occasion demands.

In FIG. 6, the sound-quality improving apparatus in the third embodiment is provided particularly with: a variable amplifier circuit 61V and a variable amplifier circuit 62V, as one example of the “amplifying device” of the present invention; and a microcomputer 6M, as one example of the “amplification factor controlling device” of the present invention. The sound-quality improving apparatus in the third embodiment preferably improves and outputs the sound quality that has deteriorated in the compressed audio signal inputted, as follows.

The variable amplifier circuit 61V is electrically connected to the medium to low-frequency BP filter 51B, and is adapted to adjust the level of the medium to low-frequency effect sound signal, as occasion demands.

The variable amplifier circuit 62V is electrically connected to the medium to high-frequency BP filter 52B, and is adapted to adjust the level of the medium to high-frequency effect sound signal, as occasion demands.

The microcomputer 6M includes, for example, a CPU (Central Processing Unit), and is electrically connected to the variable amplifier circuit 61V and the variable amplifier circuit 62V. The microcomputer 6M recognizes the compressed audio signal to be inputted, and is adapted to control the variable amplifier circuit 61V and the variable amplifier circuit 62V so as to adjust the level of each of the generated medium to low-frequency effect sound signal and the generated medium to high-frequency effect sound signal, on the basis of the compressed audio signal to be inputted.

As described above, according to the sound-quality improving apparatus in the third embodiment shown in FIG. 6, it is possible to preferably improve and output the sound quality that has deteriorated in the compressed audio signal inputted. In particular, the microcomputer 6M controls the variable amplifier circuit 61V and the variable amplifier circuit 62V, so that it is possible to generate the suitable effect sound according to the compressed audio signal to be inputted.

### (5) FOURTH EMBODIMENT

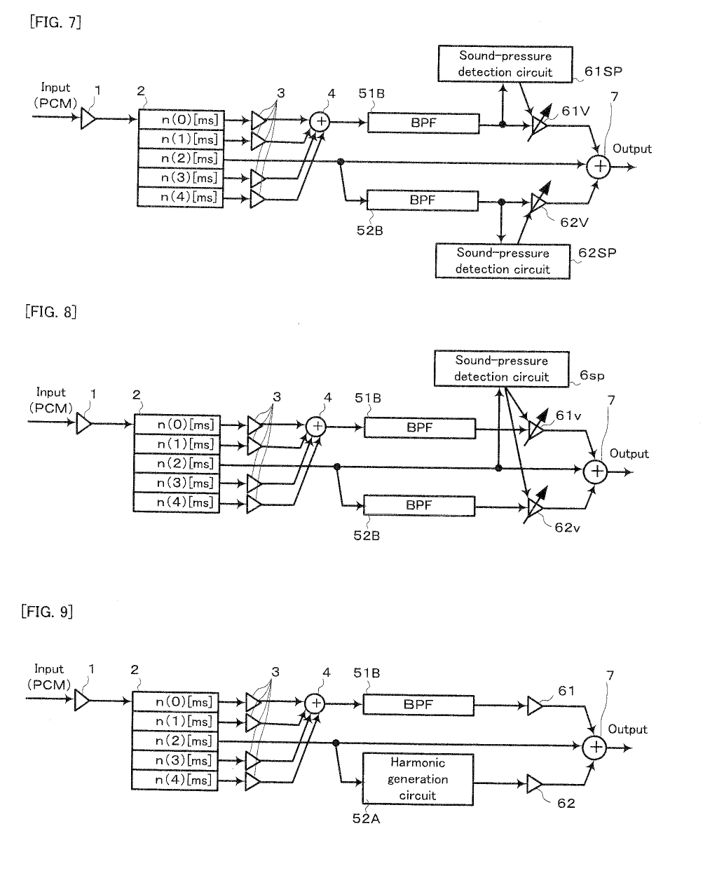

The structure of a sound-quality improving apparatus in a fourth embodiment will be explained with reference to FIG. 7 in addition to FIG. 6. FIG. 7 is a block diagram conceptually showing the structure of the sound-quality improving apparatus in the fourth embodiment. Incidentally, in FIG. 7, the same structure as that of FIG. 6 carries the same numerical reference, and the detailed explanation thereof will be omitted as occasion demands.

In FIG. 7, the sound-quality improving apparatus in the fourth embodiment is provided particularly with: a sound-pressure detection circuit 61SP and a sound-pressure detection circuit 62SP, as one example of the “sound-pressure detecting circuit” of the present invention. The sound-quality improving apparatus in the fourth embodiment preferably improves and outputs the sound quality that has deteriorated in the compressed audio signal inputted, as follows.

The sound-pressure detection circuit 61SP includes, for example, an integration circuit, is electrically connected to each of the BP filter 51B and the variable amplifier circuit 61V, and is adapted to detect the level of the sound pressure of the medium to low-frequency effect sound and adjust the variable amplifier circuit 61V in a feed-forward manner on the basis of the detected level. For example, if the detected level is relatively low, the level of the medium to low-frequency effect sound is adjusted to relatively increase the level.

The sound-pressure detection circuit 62SP also includes, for example, an integration circuit, is electrically connected to each of the BP filter 52B and the variable amplifier circuit 62V, and adjusts the level of the medium to high-frequency effect sound, as in the sound-pressure detection circuit 61SP.

As described above, according to the sound-quality improving apparatus in the fourth embodiment shown in FIG. 7, it is possible to preferably improve and output the sound quality that has deteriorated in the compressed audio signal inputted. In particular, it is possible to generate the effect sound that is more suitable for the compressed audio signal to be inputted, by changing the synthesis extent to the basic sound signal, according to the level of the sound pressures of the generated medium to low-frequency effect sound signal and the generated medium to high-frequency effect sound signal.

### (6) FIFTH EMBODIMENT

The structure of a sound-quality improving apparatus in a fifth embodiment will be explained with reference to FIG. 8 in addition to FIG. 7. FIG. 8 is a block diagram conceptually showing the structure of the sound-quality improving apparatus in the fifth embodiment. Incidentally, in FIG. 8, the same structure as that of FIG. 7 carries the same numerical reference, and the detailed explanation thereof will be omitted as occasion demands.

In FIG. 8, the sound-quality improving apparatus in the fifth embodiment is provided particularly with: a sound-pressure detection circuit 6SP, and preferably improves and outputs the sound quality that has deteriorated in the compressed audio signal inputted, as follows.

The sound-pressure detection circuit 6SP includes, for example, an integration circuit, is electrically connected to the delay circuit 2, and is adapted to detect the level of the sound pressure of the basic sound signal and adjust the variable amplifier circuit 61V and the variable amplifier circuit 62V on the basis of the detected level.

As described above, according to the sound-quality improving apparatus in the fifth embodiment shown in FIG. 8, it is possible to preferably improve and output the sound quality that has deteriorated in the compressed audio signal inputted. In particular, it is possible to synthesize each effect sound signal in the entire frequency band in a balanced manner, in accordance not with the level of the effect sound signal but with the level of the basic sound signal detected by the sound-pressure detection circuit 6SP, when the level is adjusted.

### (7) SIXTH EMBODIMENT

The structure of a sound-quality improving apparatus in a sixth embodiment will be explained with reference to FIG. 9 in addition to FIG. 2. FIG. 9 is a block diagram conceptually showing the structure of the sound-quality improving apparatus in the sixth embodiment. Incidentally, in FIG. 9, the same structure as that of FIG. 2 carries the same numerical reference, and the detailed explanation thereof will be omitted as occasion demands.

In FIG. 9, the sound-quality improving apparatus in the sixth embodiment is provided particularly with: a harmonic generation circuit 52A, as one example of the “effect-sound generating device” of the present invention. The sound-quality improving apparatus in the sixth embodiment preferably improves and outputs the sound quality that has deteriorated in the compressed audio signal inputted, as follows.

The harmonic generation circuit 52A is electrically connected to the delay circuit 2, and is adapted to generate the medium to high-frequency effect sound signal by performing a harmonic generation process on the basic sound signal, wherein the harmonic generation process is for generating an n-th harmonic sound (n is a natural number of 2 or more) of the basic sound signal.

As described above, according to the sound-quality improving apparatus in the sixth embodiment shown in FIG. 9, it is possible to preferably improve and output the sound quality that has deteriorated in the compressed audio signal inputted. In particular, it is possible to synthesize the more natural medium to high-frequency effect sound signal for the basic sound signal, by that the harmonic generation circuit 52A compensates a high-frequency component (e.g. 16 Hz or more components are cut in 128 kps MP3) cut when the compressed audio signal to be inputted is compressed.

### (8) SEVENTH EMBODIMENT

The structure of a sound=quality improving apparatus in a seventh embodiment will be explained with reference to FIG. 10 in addition to FIG. 5. FIG. 10 is a block diagram conceptually showing the structure of the sound-quality improving apparatus in the seventh embodiment. Incidentally, in FIG. 10, the same structure as that of FIG. 5 carries the same numerical reference, and the detailed explanation thereof will be omitted as occasion demands.

In FIG. 10, the sound-quality improving apparatus in the seventh embodiment is provided particularly with: a medium to high-frequency delay circuit 2′, as one example of the “another delaying device” of the present invention; medium to high-frequency amplifier circuits 3′, as one example of the “another effect-sound generating device”; a medium to high-frequency synthesis circuit 4′; and the HP filter 52H. The sound-quality improving apparatus in the seventh embodiment preferably improves and outputs the sound quality that has deteriorated in the compressed audio signal inputted, as follows.

The medium to high-frequency delay circuit 2′ includes, for example, a delaying circuit, as in the delay circuit, and is adapted to generate a plurality of delay signals which are delayed in time from the compressed audio signal transmitted by the amplifier circuit 1 electrically connected thereto. Specifically, it is adapted to generate a plurality of delay signals which are delayed for n(0′) [ms] to n(3′) [ms] (wherein n(0′) to n(3′) are predetermined real values and values near n(2)) from the compressed audio signal. At this time, in view of the peak and the dip which appear in the frequency characteristic of the medium to high-frequency effect sound signal (in particular, high-frequency), a delay time used for the generation of the medium to high-frequency effect sound signal (i.e. each time interval of n(0′) to n(3′)) is preferably shorter than that used for the generation of the medium to low-frequency effect sound signal (i.e. each time interval of n(0) to n(4)).

The medium to high-frequency amplifier circuits 3′ are electrically connected to the medium to high-frequency delay circuit 2′, and are adapted to adjust the level of each of the plurality of delay signals (e.g. the behind sound signal and the advance sound signal) generated by the medium to high-frequency delay circuit 2′ as described above, as occasion demands, as in the amplifier circuits 3.

The medium to high-frequency synthesis circuit 4′ is electrically connected to each of the medium to high-frequency amplifier circuits 3′, and is adapted to synthesize the behind sound signal and the advance sound signal in which the level is adjusted, as in the synthesis circuit 4.

The HP filter 52H is adapted to generate the medium to high-frequency effect sound signal by collectively performing a high-pass filtering process on the behind sound signal and the advance sound signal, as described above.

As described above, according to the sound-quality improving apparatus in the seventh embodiment shown in FIG. 10, it is possible to preferably improve and output the sound quality that has deteriorated in the compressed audio signal inputted. In particular, it is possible to reduce the peak and the dip which appear in the frequency characteristic of the medium to high-frequency sound signal (in particular, high-frequency), as much as possible, because different delay signals (specifically, the delay signal related to the delay circuit 2 and the delay signal related to the medium to high-frequency delay circuit 2′) are used for the generation of the medium to low-frequency sound effect signal and the generation of the medium to high-frequency sound effect signal.

### (9) EIGHTH EMBODIMENT

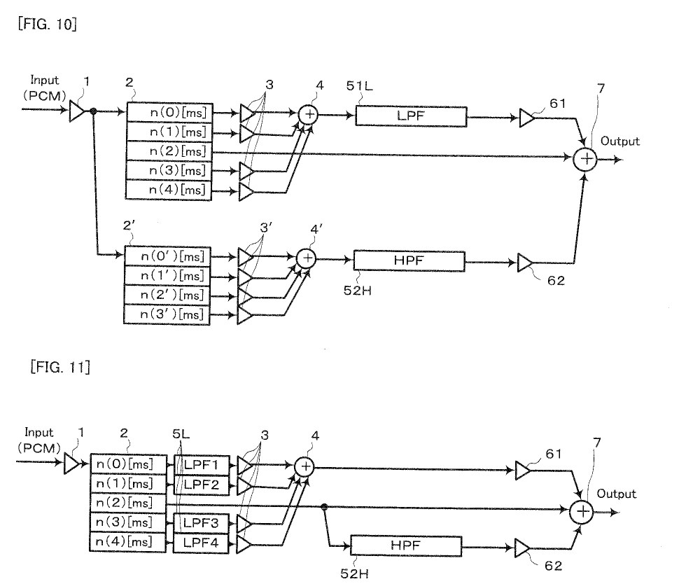

The structure of a sound-quality improving apparatus in an eight embodiment will be explained with reference to FIG. 11 in addition to FIG. 2. FIG. 11 is a block diagram conceptually showing the structure of the sound-quality improving apparatus in the eighth embodiment. Incidentally, in FIG. 11, the same structure as that of FIG. 2 carries the same numerical reference, and the detailed explanation thereof will be omitted as occasion demands.

In FIG. 11, the sound-quality improving apparatus in the eighth embodiment is provided particularly with the LP filters 5L, and performs the filtering process separately on the behind sound signal and the advance sound signal, to thereby preferably improve and output the sound quality that has deteriorated in the compressed audio signal inputted, as follows.

The LP filters 5L are individually connected to the output interfaces of the plurality of delay signals (the behind sound signal and the advance sound signal) generated by the delay circuit 2, and are adapted to perform a low-pass filtering process separately on the respective delay signals.

The HP filter 52H is electrically connected to the delay circuit 2, and is adapted to generate the medium to high-frequency effect sound signal by passing more than 4 kHz signals of the basic sound signal (e.g. a signal which is delayed for n(2) [ms] from the compressed audio signal inputted).

As described above, according to the sound-quality improving apparatus in the eighth embodiment shown in FIG. 11, it is possible to preferably improve and output the sound quality that has deteriorated in the compressed audio signal inputted. In particular, the LP filters 5L perform the low-pass filtering process individually on the respective delay signals when the medium to low-frequency sound signal is generated, so that it is possible to separately change each of the delay signals, to thereby perform finer sound-quality setting.

The structures shown in the first embodiment to the eight embodiment may be achieved by the sound-quality improving apparatus built in or externally connected to an audio reproducing apparatus, such as a MP3 player. Alternatively, the structures may be achieved by operating the audio reproducing apparatus on the basis of a sound-quality improving method provided with a delaying process, an effect-sound generating process, and a synthesizing process. Alternatively, the structures may be achieved by making a computer read a computer program and function as the delaying device and the synthesizing device.

As described above, according to the embodiments, it is possible to improve the sound quality that has deteriorated with some process in a processed audio signal obtained by performing the process, such as an audio signal inputted in a decoded status after the compression coding.

Incidentally, the present invention is not limited to the above-described embodiment, and various changes may be made, if desired, without departing from the essence or spirit of the invention which can be read from the claims and the entire specification. A sound-quality improving apparatus and method, and a computer program, which involve such changes, are also intended to be within the technical scope of the present invention.

### INDUSTRIAL APPLICABILITY

The sound-quality improving apparatus and method, and the computer program according to the present invention can be applied to a sound-quality improving apparatus for improving a sound quality that has deteriorated with compression coding in an audio signal inputted in a decoded status after the compression coding. Moreover, they can be also applied to a sound-quality improving apparatus or the like which is mounted on various computer equipment for consumer use or for commercial use, or which can be connected to various computer equipment.

1. A sound-quality improving apparatus comprising:
a delaying device for generating a basic sound signal by delaying a processed audio signal obtained by performing a predetermined type of process on an original audio signal, for a predetermined time, for generating a behind sound signal by delaying the processed audio signal for a shorter time than the predetermined time, and for generating an advance sound signal by delaying the processed audio signal for a longer time than the predetermined time;
an effect-sound generating device for generating an effect sound signal, which indicates an effect sound for a basic sound indicated by the basic sound signal, at least on the basis of the generated behind sound signal and the generated advance sound signal; and
a synthesizing device for synthesizing the generated effect sound signal with the basic sound signal.

2. The sound-quality improving apparatus according to claim 1, wherein said effect-sound generating device generates a medium to low-frequency effect sound signal, which indicates a medium to low-frequency effect sound for the basic sound, as one portion of the effect sound signal, on the basis of the generated behind sound signal and the generated advance sound signal, and generates a medium to high-frequency effect sound signal, which indicates a medium to high-frequency effect sound for the basic sound, as another portion of the effect sound signal, on the basis of the generated behind sound signal and the generated advance sound signal.

3. The sound-quality improving apparatus according to claim 1, wherein said effect-sound generating device generates the effect sound signal on the basis of the generated basic sound signal, in addition to the generated behind sound signal and the generated advance sound signal.

4. The sound-quality improving apparatus according to claim 3, wherein said effect-sound generating device generates a medium to low-frequency effect sound signal, which indicates a medium to low-frequency effect sound for the basic sound, as one portion of the effect sound signal, on the basis of the generated behind sound signal and the generated advance sound signal, and generates a medium to high-frequency effect sound signal, which indicates a medium to high-frequency effect sound for the basic sound, as another portion of the effect sound signal, on the basis of the generated basic sound signal.

5. The sound-quality improving apparatus according to claim 2, further comprising:
an amplifying device for amplifying a signal level of the generated medium to low-frequency effect sound signal at a variable amplification factor and for amplifying a signal level of the generated medium to high-frequency effect sound signal at a variable amplification factor; and
an amplification-factor controlling device for changing the variable amplification factor.

6. The sound-quality improving apparatus according to claim 5, wherein said amplification-factor controlling device has a microcomputer for controlling said amplifying device to change the variable amplification factor.

7. The sound-quality improving apparatus according to claim 5, wherein said amplification-factor controlling device has a sound-pressure detection circuit for detecting a sound pressure of the effect sound and for controlling said amplifying device to change the variable amplification factor in accordance with the detected sound pressure.

8. The sound-quality improving apparatus according to claim 5, wherein said amplification-factor controlling device has a sound-pressure detection circuit for detecting a sound pressure of the basic sound and for controlling said amplifying device to change the variable amplification factor in accordance with the detected sound pressure.

9. The sound-quality improving apparatus according to claim 1, wherein said effect-sound generating device generates a medium to low-frequency effect sound signal, which indicates a medium to low-frequency effect sound for the basic sound, as one portion of the effect sound signal, on the basis of the generated behind sound signal and the generated advance sound signal, and generates a high-frequency effect sound signal, which indicates a high-frequency effect sound for the basic sound, as another portion of the effect sound signal, on the basis of the generated basic sound signal.

10. The sound-quality improving apparatus according to claim 9, wherein said effect-sound generating device has a high-frequency generation circuit for generating an n-th harmonic sound (n is a natural number of 2 or more) of the basic sound signal, as a device for generating the high-frequency effect sound signal.

11. The sound-quality improving apparatus according to claim 1, further comprising:
another delaying device for generating a delay sound signal by delaying the processed audio signal for a time different from the predetermined time; and
another effect-sound generating device for generating a medium to high-frequency effect sound signal, which indicates a medium to high-frequency effect sound for the basic sound indicated by the basic sound signal, on the basis of the generated delay sound signal,
said effect-sound generating device generating a medium to low-frequency effect sound signal, which indicates a medium to low-frequency effect sound for the basic sound, as the effect sound signal, on the basis of the generated behind sound signal and the generated advance sound signal,
said synthesizing device synthesizing the generated medium to low-frequency effect sound signal and the generated medium to high-frequency effect sound signal, with the basic sound signal.

12. The sound-quality improving apparatus according to claim 1, wherein said effect-sound generating device performs a filtering process separately on the generated behind sound signal and the generated advance sound signal, as one portion of a process of generating the effect sound signal.

13. The sound-quality improving apparatus according to claim 1, wherein
said delaying device generates a plurality of the behind sound signals by delaying the processed audio signal for a plurality of times which are shorter than the predetermined time and which are different from each other, and generates a plurality of the advance sound signals by delaying the processed audio signal for a plurality of times which are longer than the predetermined time and which are different from each other, and
said effect-sound generating device performs a filtering process separately on the generated plurality of behind sound signals and the generated plurality of advance sound signals, as one portion of a process of generating the effect sound signal.

14. The sound-quality improving apparatus according to claim 1, wherein said effect-sound generating device collectively performs a filtering process on the generated behind sound signal and the generated advance sound signal, as one portion of a process of generating the effect sound signal.

15. The sound-quality improving apparatus according to claim 1, wherein
said delaying device generates a plurality of the behind sound signals by delaying the processed audio signal for a plurality of times which are shorter than the predetermined time and which are different from each other, and generates a plurality of the advance sound signals by delaying the processed audio signal for a plurality of times which are longer than the predetermined time and which are different from each other, and
said effect-sound generating device collectively performs a filtering process on the generated plurality of behind sound signals and the generated plurality of advance sound signals, as one portion of a process of generating the effect sound signal.

16. The sound-quality improving apparatus according to claim 1, further comprising a preprocessing device for performing a process of reducing a signal level on the processed audio signal, at a pre-stage of said delaying device.

17. A sound-quality improving method comprising:
a delaying process of generating a basic sound signal by delaying a processed audio signal obtained by performing a predetermined type of process on an original audio signal, for a predetermined time, for generating a behind sound signal by delaying the processed audio signal for a shorter time than the predetermined time, and for generating an advance sound signal by delaying the processed audio signal for a longer time than the predetermined time;
an effect-sound generating process of generating an effect sound signal, which indicates an effect sound for a basic sound indicated by the basic sound signal, at least on the basis of the generated behind sound signal and the generated advance sound signal; and
a synthesizing process of synthesizing the generated effect sound signal with the basic sound signal.

18. A computer program making a computer function as:
a delaying device for generating a basic sound signal by delaying a processed audio signal obtained by performing a predetermined type of process on an original audio signal, for a predetermined time, for generating a behind sound signal by delaying the processed audio signal for a shorter time than the predetermined time, and for generating an advance sound signal by delaying the processed audio signal for a longer time than the predetermined time;
an effect-sound generating device for generating an effect sound signal, which indicates an effect sound for a basic sound indicated by the basic sound signal, at least on the basis of the generated behind sound signal and the generated advance sound signal; and
a synthesizing device for synthesizing the generated effect sound signal with the basic sound signal.
